(19) United States
(12) Patent Application Publication
(10) Pub. No.: US 2023/0281796 A1
(43) Pub. Date: Sep. 7, 2023

(54) INSPECTION APPARATUS, INSPECTION METHOD, AND NON-TRANSITORY COMPUTER-READABLE STORAGE MEDIUM

(71) Applicant: CANON KABUSHIKI KAISHA, Tokyo (JP)

(72) Inventor: RYO KAZUMI, Kanagawa (JP)

(21) Appl. No.: 18/175,801

(22) Filed: Feb. 28, 2023

(30) Foreign Application Priority Data
Mar. 2, 2022 (JP) 2022-031410

(51) Int. Cl. G06T 7/00; H04N 1/00; H04N 1/32; G06K 7/14

(52) U.S. Cl. CPC G06T 7/001; G06K 7/1443; H04N 1/00015; H04N 1/00334; H04N 1/00456; H04N 1/32133; H04N 1/32635; G06T 2200/24; G06T 2207/20092; G06T 2207/30144; H04N 2201/3269

(57) ABSTRACT

An inspection apparatus includes at least one memory that stores instructions, and at least one processor that executes the instructions to provide a screen to display an image on which a plurality of pages is imposed and to receive a layout of an inspection area on one of the plurality of pages imposed on the displayed image based on a user instruction, and replicate the inspection area set on the one page at corresponding positions on the other pages imposed on the displayed image.

### BACKGROUND

### Field

The present disclosure relates to an inspection apparatus for inspecting whether a printing failure has occurred on an image printed on a sheet, an inspection method, and a non-transitory computer-readable storage medium.

### Description of the Related Art

There is known an inspection apparatus for inspecting whether an image has been normally printed by inspecting the image formed on a sheet printed by a printing apparatus. In recent years, there have been developed printing systems each provided with such an inspection apparatus in the middle of a conveyance path for conveying sheets printed by the printing apparatus to a discharge tray, the inspection apparatus of which scans sheets being conveyed through the conveyance path by a scanner or another device, and analyzes images as the results of printing to inspect whether the images are normally printed.

In addition, in printing business cards or a book, the processing is carried out of laying out (imposing) the images on a plurality of pages and printing on a large sheet, then cutting the printed sheet into pieces by a cutter to produce a final product, such as a business card or a book, using the cut sheets. An inspection in the above-described processing is performed by scanning the printed large sheet (sheet before being cut) obtained immediately after the images on a plurality of pages are laid out and printed on a large sheet while the sheet is conveyed to a discharge tray.

Japanese Patent Application Laid-Open No. 2020-93425 discusses a technique for inspecting a sheet on which the input images on a plurality of pages are laid out (imposed) and printed on one side of the sheet by comparing the imposed area alone corresponding to a page image designated by a user with the correct answer image. In other words, the technique in Japanese Patent Application Laid-Open No. 2020-93425 designates the page of an inspection target image by focusing on the position of each of the imposed page images printed on the sheet.

On the other hand, a partial area within a page may be particularly important depending on the type of printed material. For example, in printing a character string such as an address, a barcode, or a two-dimensional code on a page, an inspection is performed as to whether an important part such as a character string or barcode is printed without a failure. In this regard, an inspection target designated for each page on such a printed material according to the technique discussed in Japanese Patent Application Laid-Open No. 2020-93425 can include an area other than an important part, causing extra processing.

The technique discussed in Japanese Patent Application Laid-Open No. 2020-93425 designates an inspection target page, which does not designate a partial area as an inspection target area on each of a plurality of pages imposed on a sheet.

### SUMMARY

According to embodiments of the present disclosure, an inspection apparatus includes at least one memory that stores instructions, and at least one processor that executes the instructions to provide a screen to display an image on which a plurality of pages is imposed and to receive a layout of an inspection area on one of the plurality of pages imposed on the displayed image based on a user instruction, wherein the inspection area set on the one page is replicated at corresponding positions on the other pages imposed on the displayed image.

Further features of the present disclosure will become apparent from the following description of exemplary embodiments with reference to the attached drawings.

### BRIEF DESCRIPTION OF THE DRAWINGS

FIG. 1 is a schematic diagram illustrating the configurations of an information processing apparatus, an inspection apparatus, and a printing apparatus according to a first exemplary embodiment.

FIG. 2 is a block diagram illustrating the configurations of the information processing apparatus, the inspection apparatus, and the printing apparatus.

FIG. 3 is a schematic view illustrating internal configurations of the information processing apparatus, an inspection unit, the printing apparatus, and a large-capacity stacker.

FIG. 4 is a flowchart illustrating overall inspection processing.

FIG. 5A illustrates a user interface (UI) on a preview display screen to set an inspection area.

FIG. 5B illustrates the preview display screen to set the inspection area in making advanced margin settings.

FIG. 6 is a flowchart illustrating inspection setting processing.

FIG. 7 illustrates an example of calculating coordinates in inspection area replication processing.

FIG. 8 illustrates an example of a printed material according to a second exemplary embodiment.

FIG. 9 is a flowchart illustrating inspection setting processing according to the second exemplary embodiment.

FIG. 10 illustrates an example of a printed material according to a third exemplary embodiment.

FIG. 11 is a flowchart illustrating inspection setting processing according to the third exemplary embodiment.

### DESCRIPTION OF THE EMBODIMENTS

Exemplary embodiments of the present disclosure will be described below with reference to the drawings. The following exemplary embodiments are not intended to limit the present disclosure, and not all combinations of features described in the exemplary embodiments are used in solution of the present disclosure.

A partial area within a page may be particularly important depending on the type of printed material. For example, in printing a character string such as an address, a barcode, or a two-dimensional code on a page, an inspection is performed as to whether an important part such as a character string or barcode is printed without a failure. On the other hand, a technique discussed in Japanese Patent Application Laid-Open No. 2020-93425 designates an inspection target page from among a plurality of pages laid out on a sheet, which does not designate a partial area as an inspection target area on each of the pages imposed on a sheet. In other words, an inspection target page designated as with the technique discussed in Japanese Patent Application Laid-Open No. 2020-93425 can include an area other than an important part, causing extra processing.

The following exemplary embodiments illustrate an example where a partial area on each of the pages imposed on one sheet for printing can be easily set as an inspection target on the sheet.

In a first exemplary embodiment, a case will be described where variable printing for printing different data (various data) on part of each page is performed and a plurality of pages for variable printing is imposed and printed on a large sheet. In the following example, a two-dimensional code or a barcode is printed as variable data and inspection processing is performed to check whether the two-dimensional code or barcode is properly printed. In such inspection processing, the inspection can be performed by actually scanning and decoding the printed two-dimensional code or barcode and then comparing the decoded result with the correct answer data. Although in the present exemplary embodiment, an example will be described where a two-dimensional code or a barcode is set as the inspection target, the present disclosure is not limited to this example. A printed character string set as the inspection target may be decoded in optical character recognition processing for comparison with the correct answer data.

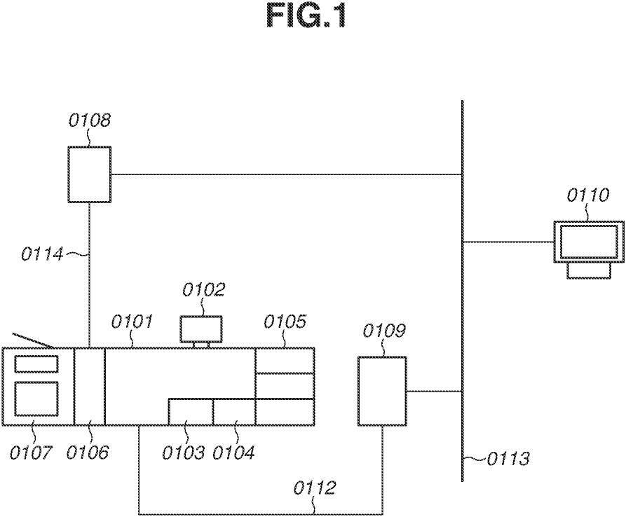

FIG. 1 is a schematic diagram illustrating the configurations of an information processing apparatus, an inspection apparatus, and an image forming apparatus according to the first exemplary embodiment. The image forming apparatus according to the present exemplary embodiment is an electrophotographic image forming apparatus. However, image forming apparatuses of different image forming types, such as an inkjet type and an offset type, may also be used as the image forming apparatus according to the present exemplary embodiment.

An image forming apparatus 0101 is connected to an information processing apparatus 0109 via a cable 0112. The information processing apparatus 0109 is connected to a client computer 0110 and an inspection apparatus 0108 via a network 0113.

The image forming apparatus 0101 includes a user interface (UI) panel 0102, a feeding deck 0103, and a feeding deck 0104. An option deck 0105 including a three-tiered feeding deck is connected to the image forming apparatus 0101. The image forming apparatus 0101 is, for example, an electrophotographic or inkjet image forming apparatus. The UI panel 0102 is, for example, a user interface including a capacitive touch panel.

The image forming apparatus 0101 further includes an inspection unit 0106 and a large-capacity stacker 0107. The inspection unit 0106 is connected to the inspection apparatus 0108 via a cable 0114.

The large-capacity stacker 0107 includes a main tray and a top tray as a discharge destination for printed sheets. Several thousands of sheets can be stacked at once on the main tray.

Print jobs are generated in the client computer 0110 and each generated print job is transmitted to the information processing apparatus 0109 via the network 0113 and is managed by the information processing apparatus 0109. Then, the print job is transmitted from the information processing apparatus 0109 to the image forming apparatus 0101 through the cable 0112, and the image forming apparatus 0101 performs printing processing on sheets. In some embodiments, print jobs may be each generated and managed in the information processing apparatus 0109, and then transmitted to the image forming apparatus 0101 via the cable 0112, and managed in the image forming apparatus 0101.

The client computer 0110, the information processing apparatus 0109, and the inspection apparatus 0108 can be connected to the cable 0112, which allows communication with the image forming apparatus 0101. In other words, the connection form in which the image forming apparatus 0101, the information processing apparatus 0109, and the client computer 0110 are connected with one another according to the present exemplary embodiment is merely an example, and various connection forms other than the connection form used in the present exemplary embodiment can be used.

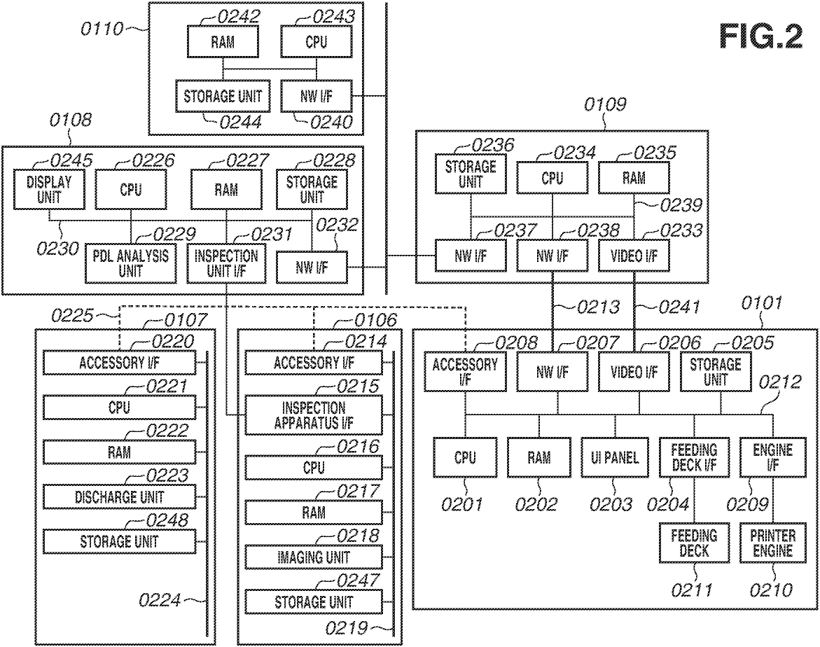

FIG. 2 is a block diagram illustrating control configurations of the image forming apparatus 0101, the inspection apparatus 0108, the large-capacity stacker 0107, the information processing apparatus 0109, and the client computer 0110 according to the present exemplary embodiment.

A central processing unit (CPU) 0201 manages performs control and arithmetic operations in each unit in the image forming apparatus 0101 via a system bus 0212. The CPU 0201 manages the run of programs that are stored in a storage unit 0205 and are loaded into a random access memory (RAM) 0202. The RAM 0202 is a type of general volatile storage devices that can be directly accessed from the CPU 0201, and is used as a work area for the CPU 0201 or other temporary data storage areas. The storage unit 0205 is a non-volatile storage device that stores programs and data, and also functions as a storage area and a working memory in operation of the image forming apparatus 0101.

An engine interface (I/F) 0209 manages communications with a printer engine 0210 and control operations. A feeding deck I/F 0204 manages communications with a feeding deck 0211 and control operations. The hardware configurations of the feeding decks 0103 and 0104 and the option deck 0105 are collectively called the feeding deck 0211. A UI panel 0203 is a hardware configuration of the UI panel 0102 and is a user interface for performing the overall operation on the image forming apparatus 0101. In the present exemplary embodiment, the UI panel 0203 includes a capacitive touch panel.

A network (NW) I/F 0207 is connected to a NW I/F 0238 of the information processing apparatus 0109 via a cable 0213, and manages communications with the information processing apparatus 0109 and the image forming apparatus 0101. In this example, the interfaces that are connected to the system bus 0212 and a system bus 0239 are directly connected. In some embodiments, the information processing apparatus 0109 and the image forming apparatus 0101 can be connected, for example, via a network, and the connection form is not particularly limited. A video I/F 0206 is connected to a video I/F 0233 via a video cable 0241, and manages communications of image data between the information processing apparatus 0109 and the image forming apparatus 0101.

The connection interface with the image forming apparatus 0101 in the information processing apparatus 0109 can have a form in which the functions of the NW I/F 0238 and the video I/F 0233 are integrated. The connection interface with the information processing apparatus 0109 in the image forming apparatus 0101 can have a form in which the functions of the NW I/F 0207 and the video I/F 0206 are integrated.

An accessory I/F 0208 is connected to an accessory I/F 0214 and an accessory I/F 0220 via a cable 0225. In other words, the image forming apparatus 0101 communicates with the inspection unit 0106 and the large-capacity stacker 0107 via the accessory I/F 0208, the accessory I/F 0214, and the accessory I/F 0220.

A CPU 0216 runs programs that are stored in a storage unit 0247 and are loaded into a RAM 0217, to perform control and arithmetic operations in each unit in the inspection unit 0106 via a system bus 0219. The RAM 0217 is a type of general volatile storage devices that can be directly accessed from the CPU 0216, and is used as a work area for the CPU 0216 or other temporary data storage areas. The storage unit 0247 functions as a temporary storage area and a working memory in operation of the inspection unit 0106. An inspection apparatus I/F 0215 is connected to an inspection unit I/F 0231 via a cable. In other words, the inspection unit 0106 communicates with the inspection apparatus 0108 via the inspection apparatus I/F 0215 and the inspection unit I/F 0231.

An imaging unit 0218 includes an imaging function (image reading function) provided with, for example, a contact image sensor (CIS). The imaging unit 0218 captures an image on a sheet that passes through the inspection unit 0106, and transmits the captured image to the inspection apparatus 0108 via the inspection apparatus I/F 0215. The CIS for the imaging unit 0218 is an example of sensors. Other types of sensors, such as a charge-coupled device (CCD) image sensor, can also be used, and the imaging method (scanning method) is not particularly limited.

A CPU 0221 manages the run of programs that are stored in a storage unit 0248 and are loaded into a RAM 0222, to perform control and arithmetic operations in each unit in the large-capacity stacker 0107 via a system bus 0224. The RAM 0222 is a type of general volatile storage devices that can be directly accessed from the CPU 0221, and is used as a work area for the CPU 0221 or other temporary data storage areas. A discharge unit 0223 manages monitoring and control of a discharge operation to the main tray and the top tray and a stacking status on each of the main tray and the top tray.

A CPU 0226 runs programs that are stored in a storage unit 0228 and are loaded into a RAM 0227, to perform control and arithmetic operations in each unit in the inspection apparatus 0108 via a system bus 0230. The RAM 0227 is a type of general volatile storage devices that can be directly accessed from the CPU 0226, and is used as a work area for the CPU 0226 or other temporary data storage areas. The storage unit 0228 is a non-volatile storage medium storing programs, and also functions as a temporary storage area and a working memory in operation of the inspection apparatus 0108. A page description language (PDL) analysis unit 0229 reads PDL data such as a portable document format (PDF), PostScript, or a printer control language (PCL) received from the client computer 0110 and the information processing apparatus 0109, and performs interpretation processing. A display unit 0245 is, for example, a liquid crystal display connected to the inspection apparatus 0108. The display unit 0245 receives a user input on the inspection apparatus 0108, and displays the state of the inspection apparatus 0108.

A CPU 0234 runs programs that are stored in a storage unit 0236 and are loaded into a RAM 0235, to perform control and arithmetic operations in each unit in the information processing apparatus 0109 via the system bus 0239. The RAM 0235 is a type of general volatile storage devices that can be directly accessed from the CPU 0234, and is used as a work area for the CPU 0234 or other temporary data storage areas. A NW I/F 0237 is connected to a NW I/F 0232 and a NW I/F 0240 via a network. The information processing apparatus 0109 communicates with the inspection apparatus 0108 via the NW I/F 0237 and the NW I/F 0232. The information processing apparatus 0109 communicates with the client computer 0110 via the NW I/F 0237 and the NW I/F 0240.

A CPU 0243 runs programs that are stored in a storage unit 0244 and are loaded into a RAM 0242, to perform control and arithmetic operations in each unit in the client computer 0110 via a system bus. The RAM 0242 is a type of general volatile storage devices that can be directly accessed from the CPU 0243, and is used as a work area for the CPU 0243 or other temporary data storage areas. The storage unit 0244 is a non-volatile storage medium storing programs, and also functions as a temporary storage area and a working memory during operation of the client computer 0110.

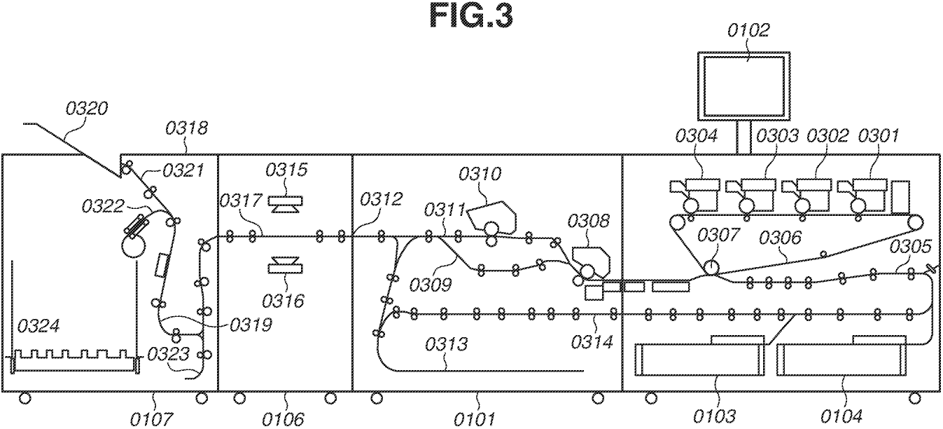

FIG. 3 is a schematic view illustrating internal configurations of the image forming apparatus 0101, the inspection unit 0106, and the large-capacity stacker 0107. The image forming apparatus 0101 receives a user input via the UI panel 0102, and displays the printing state and the state of each device. Various types of sheet can be stored in the feeding decks 0103 and 0104. In each of the feeding decks 0103 and 0104, the top sheet alone on the stored sheets can be separated from the others and conveyed to a sheet conveyance path 0305. Development stations 0301 to 0304 form toner images with yellow (Y) toner, magenta (M) toner, cyan (C) toner, and black (K) toner, respectively, to form a color image. The formed toner images are primarily transferred onto the surface of an intermediate transfer belt 0306. The intermediate transfer belt 0306 is rotated clockwise in FIG. 3, and the toner images are transferred onto the sheet conveyed from the sheet conveyance path 0305 at a secondary transfer position 0307. A fixing unit 0308 includes a pressure roller and a heating roller. While the sheet passes through a nip portion between the pressure roller and the heating roller, the fixing unit 0308 fixes the toner images by melting and pressure-bonding the toner onto the sheet. The sheet that has passed through the fixing unit 0308 is conveyed to a position 0312 through a sheet conveyance path 0309. If an additional melting and pressure-bonding process is performed depending on the type of the sheet, the sheet is conveyed to a second fixing unit 0310 through an upper sheet conveyance path after passing through the fixing unit 0308, and then the sheet is conveyed to the position 0312 through a sheet conveyance path 0311 after the additional melting and pressure-bonding process. In a duplex image forming mode, the sheet is conveyed to a sheet reversing path 0313 and is reversed through the sheet reversing path 0313, and then the sheet is conveyed to a duplex conveyance path 0314 and the image is transferred onto the second side of the sheet at the secondary transfer position 0307.

A CIS 0315 and a CIS 0316 are arranged opposite to each other in the inspection unit 0106. The CIS 0315 is a sensor for scanning the image on the upper surface of the sheet, and the CIS 0316 is a sensor for scanning the image on the lower surface of the sheet. The inspection unit 0106 uses the CIS 0315 and the CIS 0316 to scan the image on the sheet at a timing when the sheet conveyed to a sheet conveyance path 0317 reaches a predetermined position. The scanned image is transmitted to the inspection apparatus 0108 via the inspection apparatus I/F 0215 and the inspection unit I/F 0231. The CPU 0226 determines whether the received image is defective, and provides a notification about the determination result to the inspection unit 0106 via the inspection unit I/F 0231 and the inspection apparatus I/F 0215. The CPU 0216 provides a notification about the received determination result to the large-capacity stacker 0107 via the accessory I/F 0214 and the accessory I/F 0220.

The large-capacity stacker 0107 is configured to stack a large number of sheets. The large-capacity stacker 0107 includes a main tray 0324 as a tray on which sheets are stacked. The sheet that has passed through the inspection unit 0106 is conveyed into the large-capacity stacker 0107 through a sheet conveyance path 0319. The sheet is conveyed to the main tray 0324 from the sheet conveyance path 0319 through a sheet conveyance path 0322 and is stacked on the main tray 0324. The large-capacity stacker 0107 further includes a top tray 0320 as a discharge tray. The CPU 0221 discharges the sheet on which a defective image is detected by the inspection apparatus 0108 onto the top tray 0320. In outputting the sheet onto the top tray 0320, the sheet is conveyed to the top tray 0320 from the sheet conveyance path 0319 through a sheet conveyance path 0321. A reversing portion 0323 is used to reverse sheets. The reversing portion 0323 is used to stack the sheet on the main tray 0324. In stacking the sheet on the main tray 0324, the sheet is reversed once at the reversing portion 0323 so that the orientation of the conveyed sheet matches the orientation of the stacked sheet. In conveying the sheet to the top tray 0320, the sheet is directly discharged and stacked without being flipped. In this case, the sheet reversing operation in the reversing portion 0323 is not carried out.

Characterized processing of the present disclosure will be described below with reference to flowcharts and screen examples.

Programs for the image forming apparatus 0101 according to this processing procedure are stored in the storage unit 0205 of the image forming apparatus 0101, and are loaded into the RAM 0202 and are run by the CPU 0201. Programs for the inspection apparatus 0108 according to this processing procedure are stored in the storage unit 0228 of the inspection apparatus 0108, and are loaded into the RAM 0227 and are run by the CPU 0226.

Programs for the information processing apparatus 0109 according to this processing procedure are stored in the storage unit 0236 of the information processing apparatus 0109, and are loaded into the RAM 0235 and are run by the CPU 0234. Programs for the client computer 0110 according to this processing procedure are stored in the storage unit 0244 of the client computer 0110, and are loaded into the RAM 0242 and are run by the CPU 0243.

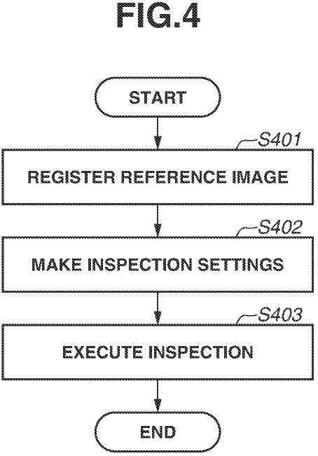

Overall inspection processing from a reference image registration operation before the inspection processing is started to the execution of the inspection processing will be described with reference to the flowchart illustrated in FIG. 4.

First, in step S401, the inspection apparatus 0108 registers a reference image. The inspection apparatus 0108 generates and registers a reference image based on the print job transmitted from the client computer 0110. This reference image is generated by converting the print job into a raster image, and is used in setting an inspection target area and parameters for inspection. As the print job for the reference image, the same print job as that used when an image is formed by the image forming apparatus 0101 is used. However, the print job to be used is not particularly limited. For example, a print job generated using part of printing target data as sample data can be used. The image generated by rasterizing the print job in the client computer 0110 or the information processing apparatus 0109 can be transmitted to the inspection apparatus 0108 and registered as the reference image.

Next, in step S402, the inspection apparatus 0108 makes inspection settings such as various kinds of inspection parameters and the position of the inspection target area, based on the user instruction made on the reference image. The inspection settings will be described in detail below.

Next, in step S403, the inspection unit 0106 scans the image printed on the sheet based on the print job to be inspected, and the inspection apparatus 0108 performs the inspection processing on the scanned image based on the inspection settings made in step S402. Specifically, when printing is performed, the inspection unit 0106 detects the conveyance of the sheet and the CIS 0315 and the CIS 0316 scan the image(s) on the sheet, and then the scanned image(s) is stored in the RAM 0227 of the inspection apparatus 0108. The inspection apparatus 0108 inspects the inspection target area on the scanned image(s) based on the inspection settings and outputs the inspection result. If the inspection target area is an area on which a quick response (QR) code® or a barcode is printed, the QR code® or barcode in the area is decoded and a data matching inspection is performed to compare the decoding result with the correct answer data and determine whether the decoding result matches the correct answer data. If the inspection target area is an image, an image matching inspection is performed to compare the image(s) on the inspection target area with the correct answer image and determine whether the image(s) matches the correct answer image.

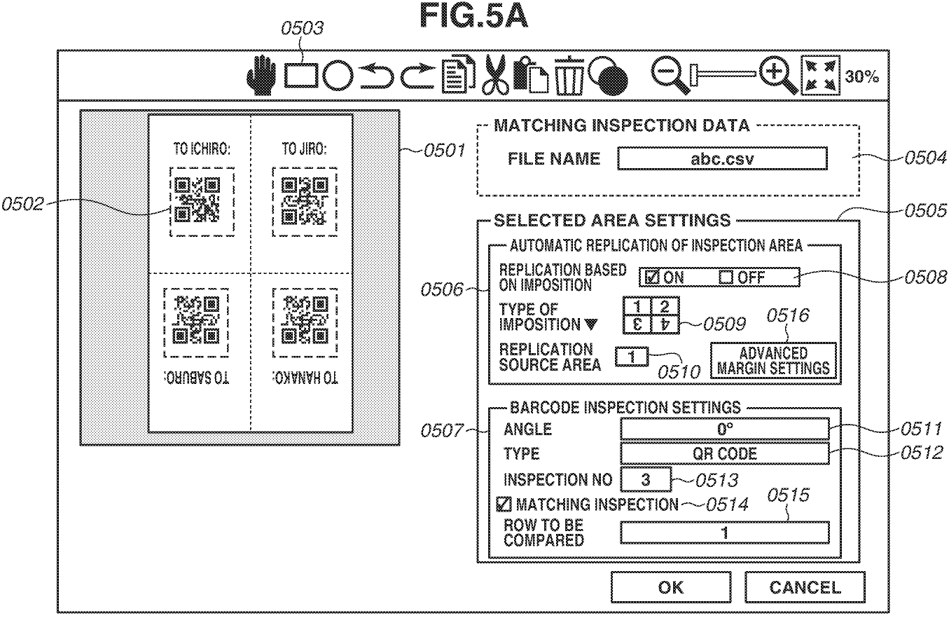

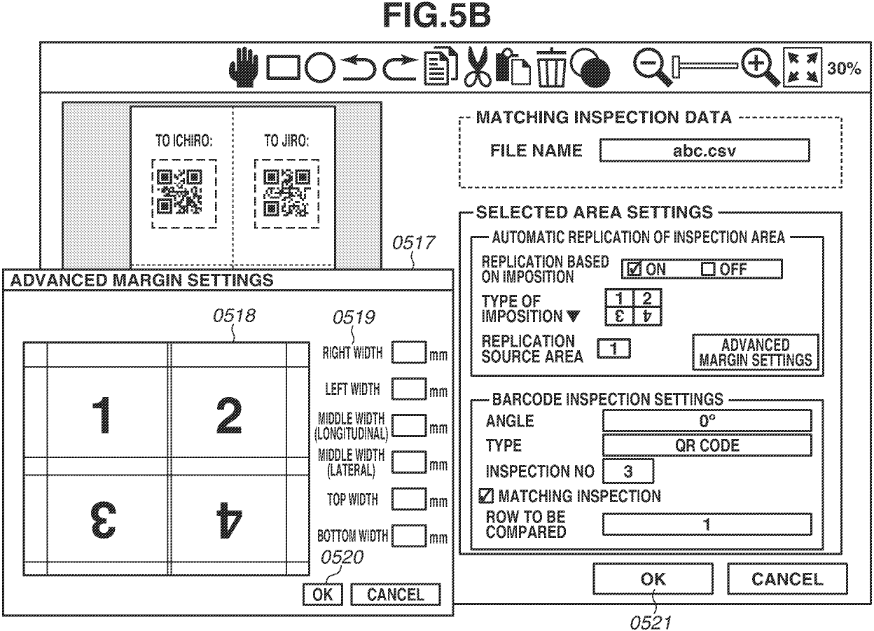

Next, the inspection settings made in step S402 will be described in detail with reference to FIG. 5A. The inspection setting processing is started by selecting the reference image registered in step S401.

A preview display screen 0501 is a preview display screen on which the reference image is displayed, and a user can designate an inspection area on the preview display screen 0501. The preview display screen 0501 is provided by the inspection apparatus 0108 and is displayed on, for example, the display unit 0245 of the inspection apparatus 0108 to receive an instruction from the user. The inspection apparatus 0108 may provide the preview display screen 0501 as a web UI so that a web browser of the client computer 0110 can display the preview display screen 0501 provided by the inspection apparatus 0108. In this case, the inspection apparatus 0108 can receive an instruction from the user of the client computer 0110 through the preview display screen 0501 displayed on the client computer 0110 as the web UI. As described below, in the present exemplary embodiment, the inspection area set based on the user instruction on one of the page images imposed on the reference image displayed as a preview can be replicated on other imposed page images. In some embodiment, the replication processing using a web UI may transmit positional information about the inspection area set based on the user instruction from the client computer 0110 to the inspection apparatus 0108, replicate the inspection area by the inspection apparatus 0108, and feed the replicated inspection area back to the client computer 0110. In other embodiments, the replication processing may transmit a script (described in JavaScript or the like) about replication processing incorporated into the web UI to the client computer 0110 and execute the script by the client computer 0110.

If the print job used in generating the reference image is a print job including an instruction to impose and print a plurality of pages on one sheet, an image on which the plurality of pages is imposed is displayed as the reference image. For example, in the example illustrated in FIG. 5A, an image corresponding to four pages is imposed on one side of a sheet. If the print job includes more pages than the pages that can be imposed on one side of a sheet, the reference image on the next sheet can be displayed when an operation to switch the reference image displayed as a preview to the next sheet is performed.

Each inspection area 0502 is a frame indicating the inspection area set on the preview image (indicated by a dotted-line frame in FIG. 5A). The inspection area 0502 is set by the following operation.

First, when the user selects an inspection area layout button 0503, a pull-down menu to select an inspection area type is displayed and the user selects a desired type from the pull-down menu. After that, when the user performs an operation to select an inspection area range by a mouse operation on the preview image, the inspection area corresponding to the selected type is set. If the user wishes to correct the position of the inspection area set once, the user can select the target inspection area by a mouse click operation, and the user can also change the size and position of the inspection area by a mouse drag operation. FIG. 5A illustrates an example where the inspection area is set at the position where a QR code® is printed.

In inspecting the QR code®, a matching inspection is performed to determine whether the result of decoding the QR code® matches the correct answer data. A setting item 0504 is used to select a correct answer data file used for the matching inspection. In performing QR code® matching inspection, pieces of correct answer data obtained by decoding the QR code® on each of the imposed and printed pages are listed.

For example, matching inspection data is stored as a comma-separated values (CSV) file in which the pieces of correct answer data on each QR code® used for matching inspection are listed in a comma-separated format.

A setting item 0505 is a setting item for the inspection area currently selected by a user operation. When one of the inspection areas set on the preview display screen 0501 is clicked by the user, the individual setting values corresponding to the selected inspection area are displayed.

After setting one inspection area on the preview display screen 0501, the user inputs on an imposition setting item 0506 information about imposition used to automatically replicate the set inspection area on other page images imposed and displayed as a preview. When the user inputs information on items 0508 to 0510, the inspection area set by the user is replicated at the corresponding positions on the other page images that are imposed on the same sheet and displayed as a preview based on the input information. The setting values on the imposition setting items for each replicated inspection area are identical to the setting values on the replication source inspection area.

A barcode inspection setting 0507 is used to set a barcode inspection. If the inspection area selected on the preview image includes a barcode or a two-dimensional code, the user makes advanced settings for the inspection. The inspection is performed based on the settings on setting items 0511 to 0515 to be described below. In replicating the barcode inspection area using the imposition setting item 0506, information on the setting items 0511 to 0515 corresponding to the replicated inspection area is calculated and replicated for each setting item.

The setting item 0508 is a checkbox used to set whether to automatically replicate the inspection area on other imposed pages. When the setting item 0508 is set to “ON”, the coordinates of the inspection area on the other page image portions where the inspection area is to be replicated are calculated based on the coordinate position of the replication source inspection area and a type of imposition 0509. In this replication processing, the barcode inspection setting 0507 for the replicated inspection area is replicated based on the barcode inspection setting 0507 for the inspection area before being replicated.

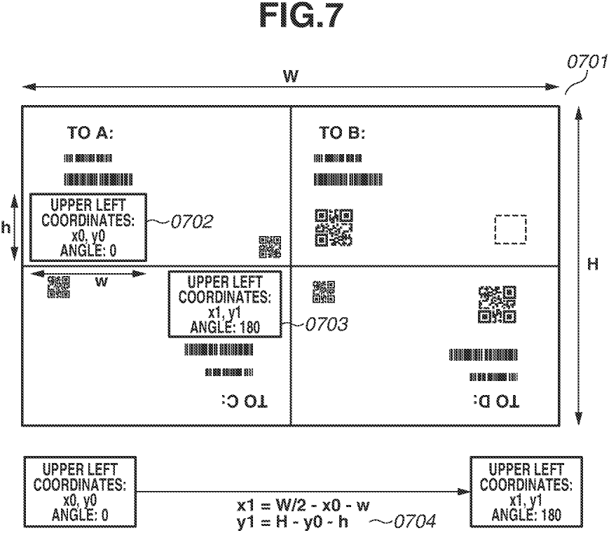

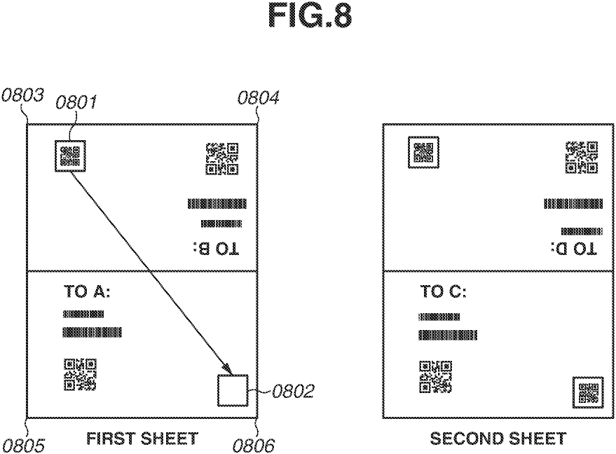

The type of imposition 0509 indicates a type of imposition. The type of imposition 0509 provides a pull-down menu from which the user selects a format, including the orientation of each page image that is preliminarily registered and imposed, the number of page images on each sheet, and an imposition order. There are various types of imposition formats. For example, some page areas are rotated as illustrated in FIGS. 7 and 8. For example, in creating a book or a booklet, sheets on which a plurality of pages is imposed and printed are folded at a boundary position between the pages by a folding machine, and the sheets are cut into pieces by a cutter such that extra parts of the sheets are cut out, for which some of the page images are rotated in printing.

The replication source area number 0510 indicates the area number indicating the area where the replication source inspection area is set. The area number indicates the area to which the inspection area belongs when the inspection area is replicated. In automatically replicating the inspection area, information about the inspection area is replicated so that the inspection area set for the page image portion corresponding to the replication source area number 0510 is set at the corresponding positions on the other imposed page images. The replication source area number 0510 is associated with each inspection area. For example, in the QR code® inspection, the inspection area on a first side of a sheet can be replicated, and in the name inspection, the inspection area on a second side of a sheet can be replicated.

The setting item 0511 indicates the angle of the barcode on the inspection area. If the selected inspection area is an inspection area other than the replicated inspection area, the user manually inputs a setting value to the setting item 0511. If the selected inspection area is a replicated inspection area, the angle with respect to the replicated inspection area is automatically calculated based on the angle set for the replication source inspection area.

The setting item 0512 indicates the barcode type on the inspection area. If the selected inspection area is an inspection area other than the replicated inspection area, the user manually input a barcode type to the setting item 0512. If the selected inspection area is a replicated inspection area, the user inputs the same barcode type as that set for the replication source inspection area.

The setting item 0513 indicates an inspection area ID. The inspection area ID is referenced when the result of decoding the inspection area is compared with the data in the reference CSV file. When the user sets the inspection area on the preview image, the ID corresponding to the set inspection area is automatically input. If the selected inspection area is a replicated inspection area, the same ID as that for the replication source inspection area is automatically input.

The checkbox 0514 is used to designate whether to perform the matching inspection to compare the data on the decoding result with the correct answer data. When the checkbox 0514 is set to “ON”, the inspection is performed by comparing the result of decoding the inspection area with the data on the corresponding ID in the reference CSV file. If the selected inspection area is a replicated inspection area, the same setting as that for the replication source inspection area is reflected in the checkbox 0514.

The setting item 0515 indicates a row to be compared. The setting item 0515 indicates the row in which the correct answer data is described in the reference CSV file for the matching inspection to compare the data obtained from the inspection area with the correct answer data. If the selected inspection area is a replicated inspection area, the same value as that for the replication source inspection area is input.

A button 0516 is used to input advanced imposition settings. When the user presses the button 0516, a window 0517 illustrated in FIG. 5B is opened so that the user can input detailed information on the imposition.

The window 0517 is an imposition input window. The window 0517 enables the user to set margins to be used for the imposition. An area 0518 is a margin setting area. The area 0518 indicates an example of imposition designated by the type of imposition 0509. The area numbers displayed on the imposition input window 0517 represent the imposition order of each page image. The orientation of the value of each area number corresponds to the orientation of the page image (e.g., area numbers 3 and 4 are displayed in a state where the area numbers 3 and 4 are rotated by 180 degrees because the page images corresponding to the area numbers 3 and 4 are imposed by being rotated by 180 degrees). Further, the area number corresponding to the replication source area is highlighted (in the example illustrated in FIG. 5B, area number “1” is highlighted with bold text as the replication source area). This makes the imposition source area distinguishable. Values input to margin value setting items 0519 are reflected in the display area to visualize the setting values input by the user.

The setting items 0519 indicate margin values. Based on the values input to the setting items 0519, the coordinates of each page image imposed on each area are calculated, and the calculated coordinates are reflected in the margin setting area 0518 in real time.

An OK button 0520 is a margin enter button. When the user selects the OK button 520, the values set to the margin value setting items 0519 are recorded on the storage unit 0228. After that, the imposition input window 0517 is closed.

An OK button 0521 is an inspection setting enter button. When the user selects the OK button 0521, all the inspection settings made on the screens illustrated in FIGS. 5A and 5B are stored in the RAM 0227.

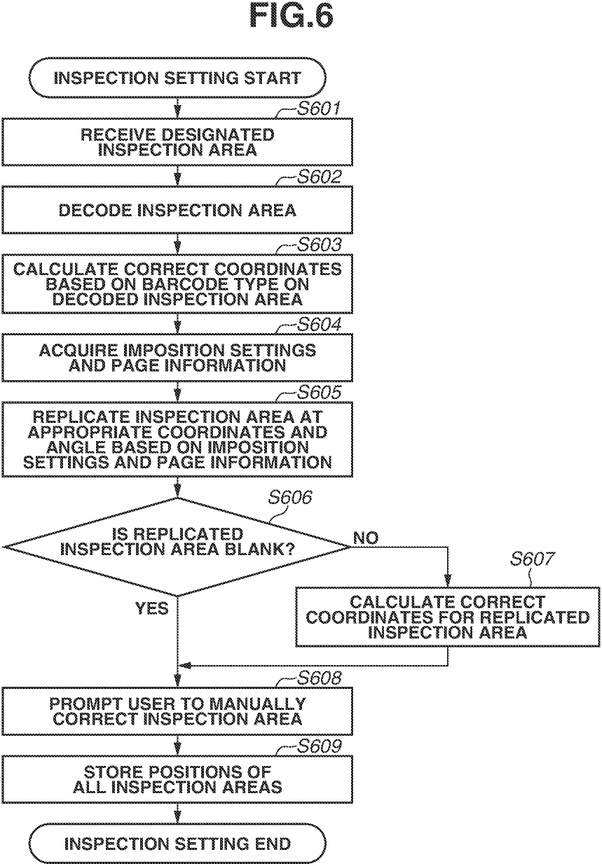

Next, inspection area setting processing will be described with reference to FIG. 6. When the inspection area setting processing is started, the screen as illustrated in FIG. 5A is displayed on the display unit 0245. The preview display screen 0501 displays as the reference image the image on which page images on the first four pages in the print job are imposed. The user selects the inspection area layout button 0503 by referring to the reference image displayed as a preview, and then designates the inspection area to be inspected.

In step S601, after the inspection area layout button 0503 is selected by the user, the CPU 0226 receives an input of information about the position of the inspection area 0502 designated by the user. In performing a barcode inspection, the CPU 0226 also receives an input of information on the inspection setting items 0511 to 0515.

In step S602, the CPU 0226 decodes the inspection area 0502 designated by the user in step S601 according to the inspection settings input in step S601.

In step S603, the CPU 0226 determines whether the barcode type designated in the setting item 0512 is correct based on the decoding result in step S602. Specifically, if the inspection area is successfully decoded based on the barcode type designated in the setting item 0512, it can be determined that the designated barcode type is correct. If the coordinates of the decoded barcode are not at the center of the area on which the coordinates are selected, or if a quiet zone cannot be secured, the position coordinates of the inspection area designated by the user are corrected based on the position coordinates obtained when the decoded barcode is detected, and the corrected position coordinates are stored in the storage unit 0228.

In step S604, the CPU 0226 acquires printing settings. The CPU 0226 waits until the type of imposition 0509, the replication source area number 0510, and the advanced imposition settings of the window 0517 opened with the button 0516 are input. In the present exemplary embodiment, the imposition settings input by the user are received, but instead may be received from another system.

In step S605, the CPU 0226 replicates the inspection area at appropriate coordinates on other imposed page image portions using the inspection area set in step S603 and the imposition settings acquired in step S604. In the example illustrated in FIG. 5A, the user sets the inspection area 0502 on the page image corresponding to the area number 1, and thus the inspection area is automatically replicated at the calculated position based on the imposition position and the imposition orientation for each page on other page images (page images corresponding to area numbers 2 to 4). The appropriate coordinates of the replication destination inspection area vary depending on the imposition method. For example, in the case of 4-in-1 printing as illustrated in FIG. 7, a relation between the upper left coordinates of a replication source inspection area 0702 and a replication destination inspection area 0703 is represented by an expression 0704. The imposition angle in the replication destination inspection area illustrated in FIG. 7 is obtained by rotating the replication source inspection area by 180 degrees. As the setting values for the barcode type, the inspection area ID, and the row to be compared, the same setting values as those for the replication source inspection area are selected.

Details of FIG. 7 will be described. An entire reference image 0701 has a width W and a height H. The replication source inspection area 0702 is designated by the user at a position (position represented by upper left coordinates (x0, y0), a width “w”, and a height “h”) within the page image corresponding to the area number 1. The position of the replication destination inspection area 0703 obtained by replicating the replication source inspection area 0702 within the page image corresponding to the area number 3 is represented by upper left coordinates (x1, y1), the width “w”, and the height “h”. In this case, the upper left coordinates of the destination inspection area 0703 are the position represented by the expression 0704. While FIG. 7 illustrates an example where the inspection area 0702 is replicated on the page image corresponding to the area number 3, the inspection area 0702 can also be replicated on the page images corresponding to the area numbers 2 and 4, respectively.

In step S606, the CPU 0226 decodes the replication destination inspection area, and checks whether the replication destination inspection area is blank.

In step S606, if the replication destination inspection area is not blank (NO in step S606), the processing proceeds to step S607. In step S607, the CPU 0226 decodes the inspection area. If the coordinates of the decoded barcode are not located at the center of the area where the coordinates are selected, or if a quiet zone cannot be secured, the correct coordinates of the inspection area are calculated based on the coordinates of the decoded barcode. In this case, it is determined whether the replication destination inspection area has an area size that satisfies a prescribed size. If the area size does not satisfy the prescribed size, the inspection area is enlarged while the data is maintained at the center of the area, obtaining the replication destination inspection area. The CPU 0226 stores the replication destination inspection area thus obtained in the storage unit 0228.

In step S606, if the replication destination inspection area is blank (YES in step S606), or after the processing of step S607 is completed, the processing proceeds to step S608. In step S608, the CPU 0226 displays the preview display screen 0501 on which the replicated inspection area is input on the display unit 0245 to prompt the user to check and correct each inspection area. Some print jobs may include pages on which no QR code® is printed. In such a print job, it may be desirable for the user to leave the replicated inspection area at it is so as to check that no QR code® is printed.

In step S609, the CPU 0226 stores the positions of all inspection areas including the inspection area corrected by the user in step S608 in the RAM 0227, and then the inspection setting processing ends.

The above-described processing makes it possible to reduce the burden on the user in inspection setting processing by replicating the inspection area.

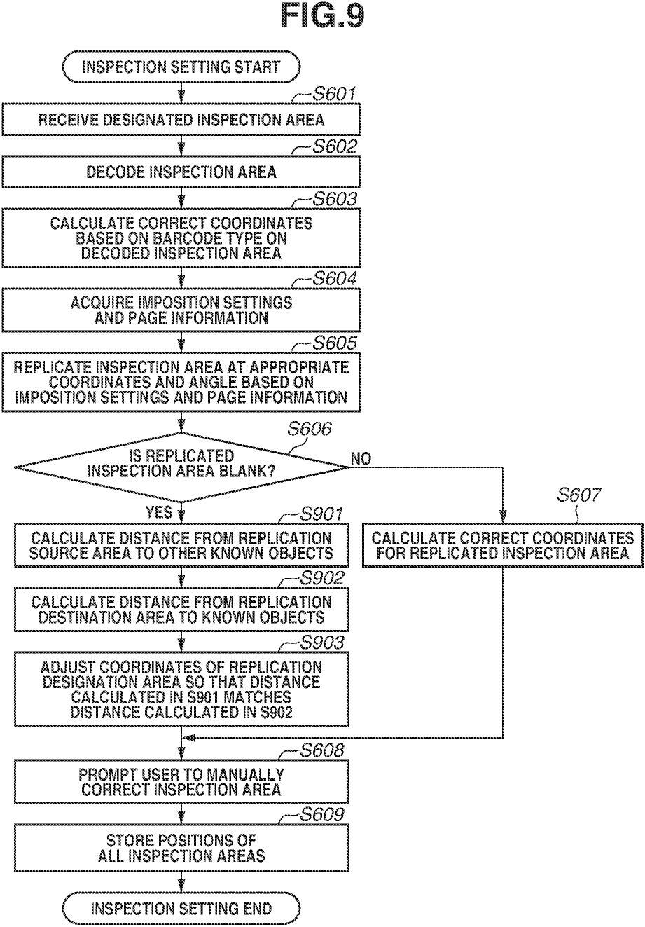

In a second exemplary embodiment, an example where the position of an inspection area is corrected if it is determined that the inspection area is blank in step S606 in replicating the inspection area will be described with reference to FIGS. 8 and 9. Descriptions of the same components as those in the first exemplary embodiment described above will be omitted.

FIG. 8 illustrates a reference image for 2-in-1 printing and an inspection area set on the reference image. FIG. 8 illustrates an example where the user designates a replication source inspection area 0801. A replication destination inspection area 0802 is an inspection area to be replicated in step S605 based on the position of the replication source inspection area 0801. However, on the reference image, data on a barcode or the like is not described in the replication destination inspection area 0802 and thus the replication destination inspection area 0802 is blank. In the first exemplary embodiment, in step S608, the calculated coordinates are used as they are and are presented as the coordinates for the inspection area, and the inspection area can be corrected by the user. In the second exemplary embodiment, a position adjustment is performed using objects located near the inspection area, and the inspection area obtained after the position adjustment is presented as the replication destination inspection area. A corner 0803, a corner 0804, a corner 0805, and a corner 0806 represent four corners of the reference image. An image printed on a first sheet in the print job is set as the reference image, and the inspection areas 0801 and 0802 set on the reference image can also be used for the second and subsequent sheets. In this case, also on the second and subsequent sheets printed in the print job, the inspection area is replicated at the corresponding positions on the inspection areas 0801 and 0802 set on the image of the first sheet.

FIG. 9 is a flowchart illustrating the position adjustment. Like step numbers refer to like processing steps that are performed as those in the flowchart illustrated in FIG. 6.

In step S606 illustrated in FIG. 9, if the CPU 0226 determines that the replication destination inspection area is blank (YES in step S606), the processing proceeds to step S901. In step S901, the CPU 0226 measures a distance from the replication source inspection area to other known objects such as four corners of the sheet. In the present exemplary embodiment, the CPU 0226 measures the distances from the replication source inspection area 0801 to the corner 0803 and the corner 0804 located in the same plane as the replication source inspection area 0801 among the four corners of the printed material.

In step S902, the CPU 0226 measures a distance from the replication destination inspection area to known objects. Specifically, the CPU 226 measures the distances from the replication destination inspection area 0802 to the corner 0805 and the corner 0806 located in the same plane as the replication destination inspection area 0802 among the four corners of the printed material.

In step S903, the CPU 0226 compares the distance calculated in step S901 with the distance calculated in step S902. The coordinates of the replication destination inspection area are adjusted such that the distance from the replication source inspection area to each corner is equal to the corresponding distance from the replication destination inspection area to each corner. In the present exemplary embodiment, the distance between the replication source inspection area 0801 and the corner 0803 corresponds to the distance between the replication destination inspection area 0802 and the corner 0806, and the distance between the replication source inspection area 0801 and the corner 0804 corresponds to the distance between the replication destination inspection area 0802 and the corner 0805.

The above-described processing makes it possible to correct the coordinates of the replication destination inspection area also when the replication destination inspection area is blank. Margins may also be taken into consideration when the inspection area is corrected using a distance from another object.

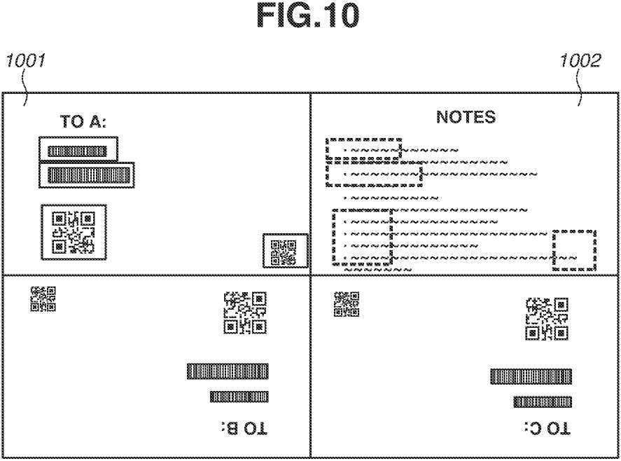

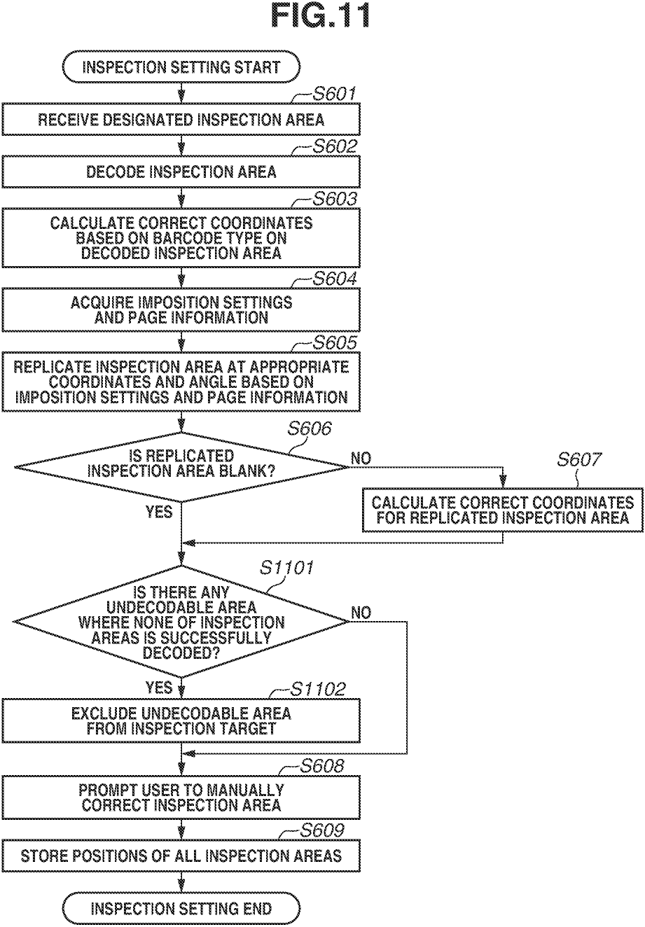

In a third exemplary embodiment, an example where replication of the inspection area on a page image portion excluded from the inspection target is prevented in step S605 will be described FIGS. 10 and 11.

FIG. 10 illustrates a reference image for 4-in-1 printing and inspection areas set on the reference image. FIG. 10 illustrates an example where four replication source inspection areas are set based on a user instruction in a page image on an area 1001 corresponding to the area number 1.

The inspection areas can be replicated on the page images corresponding to the area numbers 2 to 4, respectively. If the inspection area corresponding to the area number 2 (area 1002) is replicated, the inspection area is replicated at a position indicated by broken lines. However, in the example illustrated in FIG. 10, the page image printed on the area 1002 does not include the barcode and QR code® that can be decoded, and includes other type of data (text etc.).

FIG. 11 is a flowchart illustrating inspection setting processing when inspection target data is not included in the page images laid out on the replication destination area as illustrated in FIG. 10. Like step numbers refer to like processing steps that are performed as those in the flowchart of FIG. 6.

In step S606, if it is determined that the replication destination inspection area is blank (YES in step S606), or after the position of the replication destination inspection area is corrected in step S607, the processing proceeds to step S1101. In step S1101, the CPU 0226 determines whether the replication destination area is set as an inspection target area. In this case, the determination as to whether the area is set as the inspection target area is made by determining whether all replication destination inspection areas in the area are successfully decoded when objects included in each inspection area replicated on the area are decoded. As indicated by the area 1002 illustrated in FIG. 10, the layout on the area to be excluded from the inspection target greatly differs from the layout on the area 1001 set as the inspection target area. Even if the inspection area designated on the area 1001 were replicated on the area 1002, the replication destination inspection area could not be decoded. Thus, in the present exemplary embodiment, if none of the replication destination inspection areas is successfully decoded on the area where the inspection area is replicated, it is determined that the inspection area is to be excluded from the inspection target.

In step S1101, if the area to be excluded from the inspection target is detected (YES in step S1101), the processing proceeds to step S1102. In step S1102, all inspection areas replicated on the area are deleted to exclude the page image on the area from the inspection target.

The above-described configuration makes it possible to prevent the inspection area from being replicated on the area to be excluded from the inspection target.

The processing of replicating each inspection area is performed as described above, making it possible to reduce the burden on the user in the inspection setting processing. The second exemplary embodiment and the third exemplary embodiment may also be combined.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-031410, filed Mar. 2, 2022, which is hereby incorporated by reference herein in its entirety.

What is claimed is:

1. An inspection apparatus comprising:
at least one memory that stores instructions; and
at least one processor that executes the instructions to:
provide a screen to display an image on which a plurality of pages is imposed and to receive a layout of an inspection area on one of the plurality of pages imposed on the displayed image based on a user instruction,
wherein the inspection area set on the one page is replicated at corresponding positions on the other pages imposed on the displayed image.

2. The inspection apparatus according to claim 1, wherein the at least one processor further executes the instructions to inspect a scanned image obtained by scanning a printed material based on the inspection area set based on the user instruction and the replicated inspection area.

3. The inspection apparatus according to claim 2, wherein the inspection is a data matching inspection to compare a result of decoding an area in the scanned image corresponding to each of the inspection area set based on the user instruction and the replicated inspection area with correct answer data.

4. The inspection apparatus according to claim 3, wherein the area in the scanned image corresponding to each of the inspection area set based on the user instruction and the replicated inspection area is an area on which one of a two-dimensional code and a barcode is printed.

5. The inspection apparatus according to claim 1, wherein in a case where the replicated inspection area on the displayed image is blank, a position of the replicated inspection area is corrected based on a distance from another object.

6. The inspection apparatus according to claim 1, wherein out of the other pages on which the inspection area is to be replicated, the inspection area is controlled not to be replicated on a page on which none of the inspection areas to be replicated is successfully decoded.

7. An inspection method to be executed by an inspection apparatus, the inspection method comprising:
providing a screen to display an image on which a plurality of pages is imposed and to receive a layout of an inspection area on one of the plurality of pages imposed on the displayed image based on a user instruction; and
replicating the inspection area set on the one page at corresponding positions on the other pages imposed on the displayed image.

8. The inspection method according to claim 7, further comprising inspecting a scanned image obtained by scanning a printed material based on the inspection area set based on the user instruction and the replicated inspection area.

9. The inspection method according to claim 8, wherein the inspection is a data matching inspection to compare a result of decoding an area in the scanned image corresponding to each of the inspection area set based on the user instruction and the replicated inspection area with correct answer data.

10. The inspection method according to claim 9, wherein the area in the scanned image corresponding to each of the inspection area set based on the user instruction and the replicated inspection area is an area on which one of a two-dimensional code and a barcode is printed.

11. The inspection method according to claim 7, wherein in a case where the replicated inspection area on the displayed image is blank, a position of the replicated inspection area is corrected based on a distance from another object.

12. The inspection method according to claim 7, wherein out of the other pages on which the inspection area is to be replicated, the inspection area is controlled not to be replicated on a page on which none of the inspection areas to be replicated is successfully decoded.

13. A non-transitory computer-readable storage medium that stores a program, wherein the program causes a processor to perform:
providing a screen to display an image on which a plurality of pages is imposed and to receive a layout of an inspection area on one of the plurality of pages imposed on the displayed image based on a user instruction; and
replicating the inspection area set on the one page at corresponding positions on the other pages imposed on the displayed image.

14. The non-transitory computer-readable storage medium according to claim 13, wherein the at least one processor further executes the instructions to inspect a scanned image obtained by scanning a printed material based on the inspection area set based on the user instruction and the replicated inspection area.

15. The non-transitory computer-readable storage medium according to claim 14, wherein the inspection is a data matching inspection to compare a result of decoding an area in the scanned image corresponding to each of the inspection area set based on the user instruction and the replicated inspection area with correct answer data.

16. The non-transitory computer-readable storage medium according to claim 15, wherein the area in the scanned image corresponding to each of the inspection area set based on the user instruction and the replicated inspection area is an area on which one of a two-dimensional code and a barcode is printed.

17. The non-transitory computer-readable storage medium according to claim 13, wherein in a case where the replicated inspection area on the displayed image is blank, a position of the replicated inspection area is corrected based on a distance from another object.

18. The non-transitory computer-readable storage medium according to claim 13, wherein out of the other pages on which the inspection area is to be replicated, the inspection area is controlled not to be replicated on a page on which none of the inspection areas to be replicated is successfully decoded.
